(19) United States
(12) Patent Application Publication
(10) Pub. No.: US 2025/0274035 A1
(43) Pub. Date: Aug. 28, 2025

(54) METHOD TO OPTIMALLY SYNCHRONIZE SWITCHING PULSES OF SERIES CONNECTED CONVERTERS WITHOUT ANY COMMUNICATION

(71) Applicant: HANWHA SOLUTIONS CORPORATION, Seoul (KR)

(72) Inventors: Ivan PETRIC, Seoul (KR); Milan ILIC, Seoul (KR)

(73) Assignee: HANWHA SOLUTIONS CORPORATION, Seoul (KR)

(21) Appl. No.: 18/775,266

(22) Filed: Jul. 17, 2024

Related U.S. Application Data
(60) Provisional application No. 63/558,521, filed on Feb. 27, 2024.

(51) Int. Cl. H02M 1/14; H02M 7/539

(52) U.S. Cl. CPC H02M 1/143; H02M 7/539

(57) ABSTRACT

A power converting system may include a plurality of power converting devices electrically connected to each other, each of the plurality of power converting devices including at least one switching node, and a plurality of controllers each connected to the plurality of power converting devices, each of the plurality of controllers configured to, sample a current associated with the plurality of power converting devices electrically connected to each other over a desired time period, obtain a ripple cost function value of the current associated with the plurality of power converting devices electrically connected to each other based on the samples of the current, obtain a voltage phase shift perturbation value associated with the at least one switching node of the connected power converting device, and control a switching frequency of the connected power converting device based on the ripple cost function value and the voltage phase shift perturbation value.

### CROSS-REFERENCE TO RELATED APPLICATION

This U.S. non-provisional application claims the benefit of priority from U.S. Provisional Application No. 63/558,521, filed on Feb. 27, 2024, in the USPTO, the entire disclosure of which is incorporated by reference herein.

### BACKGROUND

Various example embodiments relate to a method for synchronizing switching pulses of connected power converter devices without communication between the power converter devices, systems including the same, and/or apparatuses for performing the same. For example, the method may provide improved and/or optimal synchronization of the switching pulses of series-connected power converters, such as voltage source inverters, etc., without communication between the power converters.

In power converting systems, such as photovoltaic (PV) systems, residential battery systems, or the like, a plurality of power converting devices are electrically connected in series to form one electrical grid-connected terminal which outputs (or receives) power from the electrical grid as a combined unit. Because multiple power converting devices (e.g., power inverters, etc.) are connected in series, lower voltage components may be used for the individual power converting device in comparison to a similar system including a single power converting device, thereby reducing the voltage stress placed on each individual power converting device, and increasing the reliability of the power converting system. This further results in a reduction of overall system cost and size. However, ripples in the electrical current being output by the plurality of power converting devices may be larger, which increases power loss and inefficiency in the power converting system. While the use of larger output filters, e.g., larger inductors and/or capacitors, may reduce the size of the current ripples of the power converting system, the larger output filters increase the cost, size, and/or weight of the power converting system.

### SUMMARY

At least one example embodiment relates to a power converting system.

In at least one example embodiment, the power converting system may include a plurality of power converting devices electrically connected to each other, each of the plurality of power converting devices including at least one switching node, and a plurality of controllers each connected to the plurality of power converting devices, each of the plurality of controllers configured to, sample a current associated with the plurality of power converting devices electrically connected to each other over a desired time period, obtain a ripple cost function value of the current associated with the plurality of power converting devices electrically connected to each other based on the samples of the current, obtain a voltage phase shift perturbation value associated with the at least one switching node of the connected power converting device, and control a switching frequency of the connected power converting device based on the ripple cost function value and the voltage phase shift perturbation value.

Some example embodiments provide that each controller of the plurality of controllers is further configured to control the switching frequency of the connected power converting device by, demodulating the ripple cost function value using the voltage phase shift perturbation value, filtering the demodulated ripple cost function value, and performing compensation on the filtered and demodulated cost function value.

Some example embodiments provide that each controller of the plurality of controllers is further configured to perform compensation on the filtered and demodulated cost function value by performing at least one of, integral control on the filtered and demodulated cost function value, proportional control on the filtered and demodulated cost function value, proportional-integral control on the filtered and demodulated cost function value, proportional-integral-derivative control on the filtered and demodulated cost function value, non-linear control on the filtered and demodulated cost function value, or any combinations thereof.

Some example embodiments provide that each controller of the plurality of controllers is further configured to filter the demodulated ripple cost function value using at least one of, a moving average filter, a low-pass filter, a notch filter, a bandpass filter, or any combinations thereof.

Some example embodiments provide that each controller of the plurality of controllers is further configured to control the switching frequency of the connected power converting device by, determining a total phase shift associated with the at least one switching node of the connected power converting device based on the voltage phase shift perturbation value and a compensated value of the demodulated and filtered ripple cost function value.

Some example embodiments provide that each controller of the plurality of controllers is further configured to control the switching frequency of the connected power converting device by, adjusting the switching frequency of at least one terminal of the connected power converting device based on the determined total phase shift.

Some example embodiments provide that each controller of the plurality of controllers is further configured to control the switching frequency of the connected power converting device by, obtaining a previous switching frequency of the at least one terminal of the connected power converting device, and adjusting the switching frequency of the at least one terminal of the connected power converting device based on the determined total phase shift and the obtained previous switching frequency.

Some example embodiments provide that the plurality of controllers is equal to N controllers, wherein N is an integer greater than or equal to 1, the plurality of power converting devices is equal to N power converting devices, and the system further comprises, an N+1th power converting device connected to the plurality of power converting devices, the N+1th power converting device including at least one N+1th switching node, and an N+1th controller connected to the N+1th power converting device, the N+1th controller configured to provide a fixed switching frequency to the at least one N+1th switching node.

Some example embodiments provide that the plurality of power converting devices are at least one of, voltage source inverters, current source inverters, AC-DC converters, DC-DC converters, DC-AC converters, AC-AC converters, or any combinations thereof.

Some example embodiments provide that the plurality of power converting devices are connected in series.

Some example embodiments provide that the system may further include a plurality of photovoltaic (PV) modules connected to a corresponding power converting device of the plurality of power converting devices, each of the PV modules configured to, harvest solar energy, and output the harvested solar energy as direct current (DC) power to the corresponding power converting device, wherein the corresponding power converting device is further configured to convert the DC power to the current associated with the plurality of power converting devices electrically connected to each other.

At least one example embodiment relates to a method of operating a power converting system.

In at least one example embodiment, the method may include sampling a current associated with a plurality of power converting devices over a desired time period, the plurality of power converting devices electrically connected to each other, each of the plurality of power converting devices including at least one switching node, obtaining a ripple cost function value of the current associated with the plurality of power converting devices electrically connected to each other based on the samples of the current, obtaining voltage phase shift perturbation values associated with each of the at least one switching nodes of the plurality of power converting devices, and controlling a switching frequency of each power converting device of the plurality of power converting devices based on the ripple cost function value and the voltage phase shift perturbation value associated with the power converting device.

Some example embodiments provide that the controlling the switching frequency of each of the power converting devices further includes, demodulating the ripple cost function value associated with each of the power converting devices using the voltage phase shift perturbation value associated with the power converting device, filtering the demodulated ripple cost function value associated with each of the power converting devices, and performing compensation on the filtered and demodulated ripple cost function value associated with each of the power converting devices.

Some example embodiments provide that the performing compensation on the filtered and demodulated cost function value includes at least one of, performing integral control on the filtered and demodulated cost function value associated with each of the power converting devices, performing proportional control on the filtered and demodulated cost function value associated with each of the power converting devices, performing proportional-integral control on the filtered and demodulated cost function value associated with each of the power converting devices, performing proportional-integral-derivative control on the filtered and demodulated cost function value associated with each of the power converting devices, non-linear control on the filtered and demodulated cost function value, or any combinations thereof.

Some example embodiments provide that the filtering the demodulated ripple cost function value further includes filtering the demodulated ripple cost function value using at least one of, a moving average filter, a low-pass filter, a notch filter, a bandpass filter, or any combinations thereof.

Some example embodiments provide that the controlling the switching frequency of each power converting device of the plurality of the power converting devices further includes, determining a total phase shift associated with the at least one switching node of each of the power converting devices based on the voltage phase shift perturbation value associated with each of the converting devices and a compensated value of the demodulated and filtered ripple cost function value associated with each of the power converting devices.

Some example embodiments provide that the controlling the switching frequency of each power converting device of the plurality of the power converting devices further includes, obtaining a previous switching frequency of at least one terminal of each of the power converting devices, and adjusting the switching frequency of the at least one terminal of each of the power converting devices based on the determined total phase shift and the obtained previous switching frequency of the at least one terminal of each of the power converting devices.

Some example embodiments provide that the plurality of power converting devices is equal to N power converting devices, wherein N is an integer equal to or greater than 1, and the method further comprises, controlling an N+1th power converting device connected to the plurality of power converting devices by providing a fixed switching frequency to at least one N+1th switching node included in the N+1th power converting device.

Some example embodiments provide that the plurality of power converting devices are at least one of, voltage source inverters, current source inverters, AC-DC converters, DC-DC converters, DC-AC converters, AC-AC converters, or any combinations thereof, the plurality of power converting devices are connected to a plurality of photovoltaic (PV) modules, the plurality of power converting devices are connected in series, and the method further comprises, receiving solar energy harvested by the plurality of PV modules, and converting the solar energy to the current associated with the plurality of power converting devices electrically connected to each other using each of the plurality of power converting devices.

At least one example embodiment is directed to a photovoltaic (PV) power converting system.

In at least one example embodiment, the PV power converting system may include a plurality of power converting devices connected to a plurality of photovoltaic (PV) modules, the plurality of power converting devices electrically connected to each other, each of the plurality of power converting devices including at least one switching node, and a plurality of controllers each connected to the plurality of power converting devices, each of the plurality of controllers configured to, sample a current associated with the plurality of power converting devices electrically connected to each other over a desired time period, obtain a ripple cost function value of the current associated with the plurality of power converting devices electrically connected to each other based on the samples of the current, obtain a voltage phase shift perturbation value associated with the at least one switching node of the connected power converting device, and control a switching frequency of the connected power converting device based on the ripple cost function value and the voltage phase shift perturbation value.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates an example power converting system including a plurality of power converting devices according to at least one example embodiment;

FIG. 2 illustrates an example power converting device of the example power converting system of FIG. 1 according to at least one example embodiment;

FIGS. 3A and 3B are example timing diagrams illustrating the effect of phase synchronization of power converting devices on an output current according to some example embodiments;

FIG. 4A illustrates an example functional block diagram of the controller of the power converting device according to some example embodiments;

FIG. 4B illustrates an example functional block diagram of the power converting system according to some example embodiments;

FIGS. 5A and 5B are flowcharts illustrating an example method of operating the power converting system according to at least one example embodiment;

FIG. 6 is an example phase change control system according to at least one example embodiment; and

FIGS. 7A and 7B are example graphs illustrating the resulting changes in phase shift and current ac RMS of the example power converting system according to at least one example embodiment.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone or server, to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Various example embodiments relate to a method for synchronizing switching pulses of connected power converter devices without communication between the power converter devices, systems including the same, and/or apparatuses for performing the same.

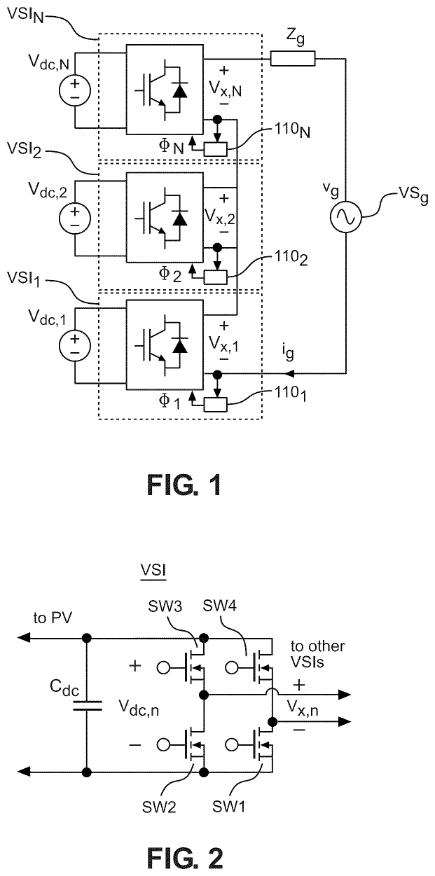

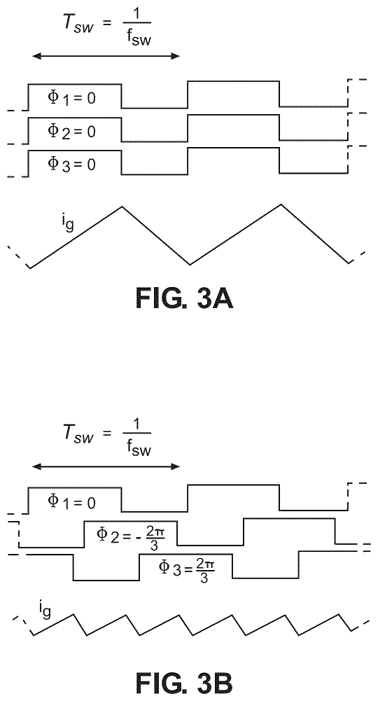

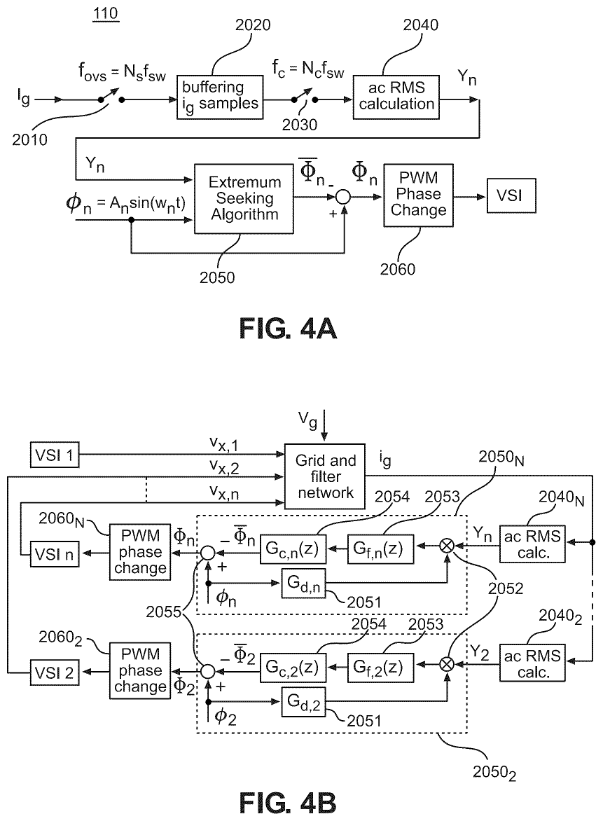

FIG. 1 illustrates an example power converting system including a plurality of power converting devices according to at least one example embodiment. FIG. 2 illustrates a power converting device of the example power converting system of FIG. 1. FIGS. 3A and 3B are example timing diagrams illustrating the effect of phase synchronization of power converting devices on an output current according to some example embodiments.

Referring now to FIG. 1, a power converting system may include a plurality of power converting devices, such as a plurality of power converting devices may be voltage source inverters (VSI) VSI1, VSI2, and VSIn, where n is an integer, but the example embodiments are not limited thereto, and for example, one or more of the power converting devices may be current source inverters, AC-DC converters, DC-DC converters, DC-AC converters, and/or AC-AC converters, etc. While FIG. 1 illustrates three power converting devices, the example embodiments are not limited thereto, and there may be two or more power converting devices (e.g., power converters, etc.) included in the system. Additionally, while FIG. 1 illustrates a single-phase power converting system, the example embodiments are not limited thereto, and the power converting system may be a multi-phase power converting system, e.g., a three-phase system, etc.

As shown in FIG. 1, the plurality of power converting devices VSI1, VSI2, and VSIn, may be connected in series to each other, and may further be connected in series to a grid filter Zg and a grid voltage source Vg. In some example embodiments, the grid filter Zg may represent a grid filter (e.g., a passive filter, etc.) and/or a grid impedance connected to an electrical grid, and the grid voltage source Vg may represent an external power source, such as the electrical utility company, etc., but the example embodiments are not limited thereto. According to some example embodiments, one or more of the VSI may also have its own output filter (not shown), and the grid filter Zg may be a representation of the combination of the output filters of the individual VSIs, but the example embodiments are not limited thereto.

Each of the power converting devices VSI may be connected to a voltage source Vdc, e.g., Vdc1 to Vdcn, but are not limited thereto. For example, the voltage sources Vdc1 to Vdc3 may be photovoltaic (PV) modules for harvesting PV energy (e.g., solar energy) using PV cells. The power converting devices VSI1 to VSIn may convert direct current (DC) electricity output by the PV modules Vdc1 to Vdcn into alternating current (AC) electricity and output the AC electricity through Vx1 to Vxn to the electrical grid. Because the plurality of power converting devices are connected in series, the switched node voltages output by each of the plurality of power converting devices (e.g., Vx1 to Vxn) are summed together, while the current output by each of the power converting devices is the same for the entire circuit. In other words, the current, Ig, output by each of the power converting devices is the same as each other.

Referring now to FIGS. 1 and 2, a power converting device, such as VSIn of FIG. 1, may include a capacitor Cdc and/or at least one switch, such as switches SW1 to SW4, etc., but the example embodiments are not limited thereto, and for example, there may be a greater or lesser number of capacitors and/or switches included in the power converting device VSIn. The capacitor Cdc may be connected in parallel to the terminals of the voltage source Vdc, e.g., a PV module, etc., and may store energy from the voltage source Vdc in a first mode, or may output energy to the voltage source Vdc, when the power converting device VSIn is in a second mode. The capacitor Cdc may be connected in parallel to one or more switching legs, e.g., SW2 and SW3 and/or SW1 and SW4, etc., which may be connected to the terminal of the power converting device VSIn, and outputs a voltage Vxn at a current Ig. For example, the power converting device VSIn may include four switches, but the example embodiments are not limited thereto, and for example, there may be a greater or lesser number of switches in the power converting device VSIn. As shown in FIG. 1, the terminal may be connected to the remainder of the electrical circuit of the power converting system of FIG. 1, and the switches SW1 to SW4 of the power converting device VSIn may control the output of the energy stored in the capacitor Cdc and/or the voltage source Vdc to the electrical grid (e.g., the grid filter Zg and/or the grid voltage source Vg, etc.) and/or may control the input of energy from the electrical grid to the capacitor Cdc and/or the voltage source Vdc, but the example embodiments are not limited thereto. Additionally, the power converting device VSIn may further include a controller 110n (e.g., processing circuitry, processor, microcontroller, etc.) for controlling the operation of the power converting device VSIn, and more specifically, for controlling and/or adjusting the switching frequency of the at least one switch of the power converting device VSIn. The controller 110n may be implemented as processing circuitry, and the processing circuitry may include hardware or hardware circuit including logic circuits; a hardware/software combination such as a processor executing software and/or firmware; or a combination thereof. For example, the processing circuitry more specifically may include (and/or be included in) a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

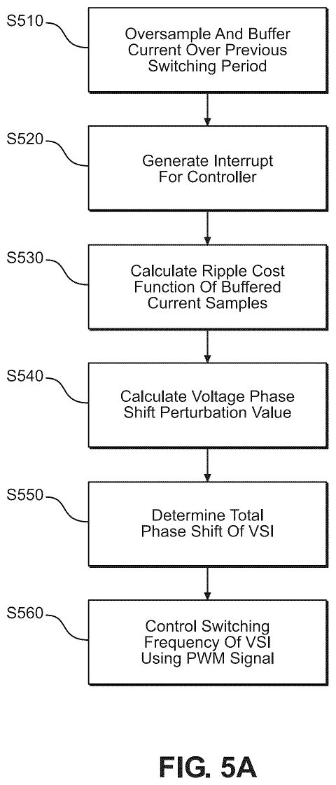

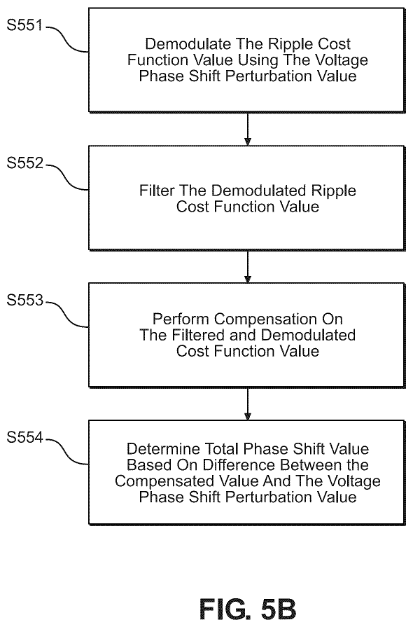

Additionally, the controller 110n and/or the power converting device VSIn may include memory (not shown) which may include computer-readable program code stored in a non-transitory computer-readable medium. The computer-readable program code may be provided to a variety of computers or processors of other data processing devices. The term “non-transitory,” as used herein, is a description of the medium itself (e.g., as tangible, and not a signal) as opposed to a limitation on data storage persistency (e.g., volatile memory vs. non-volatile memory, etc.). For example, the non-transitory computer-readable recording medium may be any tangible medium that can store or include the program in or connected to an instruction execution system, equipment, and/or device, and may include a random access memory (RAM), a read only memory (ROM), and/or a non-volatile mass storage device, such as a disk drive, and/or a solid state drive, etc. The memory may include, for example, special purpose and/or custom computer readable instructions to be executed by the controller 110n, etc. In at least some example embodiments, such computer readable instructions may be loaded from a non-transitory computer-readable storage medium independent of the memory, using a flash memory device, etc. (not illustrated). For example, the memory may include various special purpose program code including the computer executable instructions which may cause the controller 110n to perform one or more of the methods of the example embodiments, such as special purpose program code associated with the operations to be discussed in greater detail in connection with FIGS. 4A to 5B, etc.

Additionally, the controller 110n is configured to execute processes by retrieving the program code (e.g., the computer readable instructions) and data from the memory to process them, thereby executing special purpose control and functions of the entire power converting device VSIn. Once the special purpose program instructions are loaded into the controller 110n, the controller 110n executes the special purpose program instructions, thereby transforming the controller 110n into a special purpose processor, for example, a special purpose processor to perform one or more of the methods described below in connection with FIGS. 4A to 5B.

In at least one example embodiment the controller 110n and the memory may be integrated, e.g., as a printed circuit board assembly (PCBA), a system-on-chip, and/or the like. In other words, the controller 110n and the memory may be combined into a single component, but the example embodiments are not limited thereto.

Ripples in the current output by the series-connected plurality of power converting devices VSI1 to VSIn may be increased by clock drift in system clocks (not shown) included in the controllers of the power converting devices which causes the power converting devices VSI1 to VSIn to become desynchronized. Accordingly, there is a desire to synchronize the switching frequencies f_{sw} of the series-connected plurality of power converting devices VSI1 to VSIn to correct and/or reduce the desynchronization of the power converting devices, thereby reducing the magnitude of the current ripples and improving the power efficiency and reliability of the power converting devices. When the magnitudes of the current ripples are reduced, the total cost of the power converting system of one or more of the example embodiments may be reduced by allowing for the use of lower switching frequency, smaller output passive grid filters and/or output grid filters, etc. However, while it is possible to add communication lines between the power converting devices to share information regarding synchronization between the power converting devices, such as using Ethernet communication, etc., it is not practicable and/or may be undesirable to do so because of decreased reliability due to problems related to increased wiring between the power converting devices, increased cost, and/or increased installation complexity from the addition of communication lines between the power converting devices. Accordingly, there is also a desire for a method to synchronize the switching waveforms, switching node voltages, and/or phases of the switched node voltages, etc., of the connected power converter devices without any communication between the power converting devices in order to decrease and/or minimize the current ripple, or in other words, there is a desire for the independent and/or autonomous phase synchronization of the power converter devices including, for example, using extremum-seeking control, etc.

Therefore, according to at least one example embodiment, a voltage phase shift Φᵢ, (also referred to as a total voltage phase shift angle, phase shift angle, phase shift, etc.) of each of the power converting devices VSI1 to VSIn may be independently adjusted to reduce and/or minimize the magnitude of the current ripple being injected to the electrical grid.

Referring now to FIG. 3A and FIG. 3B, FIG. 3A illustrates a current Ig output by three power converting devices (e.g., VSI1 to VSIn of FIG. 1) when the voltage phase shift angles Φ₁ to Φ₃ of the power converting devices are the same (e.g., the phase shifts are set to 0), and FIG. 3B illustrates the current Ig when the phase shift angles Φ₁ to Φ₃ of the switching frequencies f_{sw} of the power converting devices are offset to improved and/or optimized phase shift offsets.

More specifically, according to at least one example embodiment wherein the series-connected power converting devices of the power converting system are balanced, e.g., all of the power converting devices have the same input voltages and the same switch duty cycles, the phase shift angle Φᵢ between each of the power converting devices of the system may be determined based on the following equation:

$${Φ}_{i} = 2 π / n , \qquad [ Equation 1 ]$$

where n is the number of series-connected power converting devices in the system. For example, where n=3, the differences in the phase shift angles may be Φ₁=0, Φ₂=−2π/3, and Φ₃=2π/3, etc. However, the example embodiments are not limited thereto, and in systems that are not balanced, other phase shift angles Φᵢ may be used.

Accordingly, as shown in FIG. 3B, the voltage phase shifts of the three power converting devices may be offset by 2π/3, which reduces the magnitude of the output current Ig in comparison to the output current Ig of FIG. 3A, where the three power converting devices have the same voltage phase shift offset.

However, because it is desired that the plurality of power converting devices VSI1 to VSIn do not communicate with each other, one or more of the power converting devices may independently calculate their own voltage phase shift angle, without knowing the number of other power converting devices in the electrical system and/or the phase angles of the other power converting devices in the electrical system. According to at least one example embodiment, one or more of the power converting devices VSI of the electrical system may calculate its own voltage phase shift angle based on a calculated current ripple cost function of the output current Ig and control its own switching frequency based on the ripple cost function value and the voltage phase shift perturbation value.

While certain components of a power converting system and a power converting device are shown in FIGS. 1 and 2, the example embodiments are not limited thereto, and the power converting system and/or power converting device may include components other than those shown in FIGS. 1 and 2, which are desired, necessary, and/or beneficial for operation of the underlying power converting system, electrical system, and/or power converting device, such as monitoring equipment, energy storage equipment, etc.

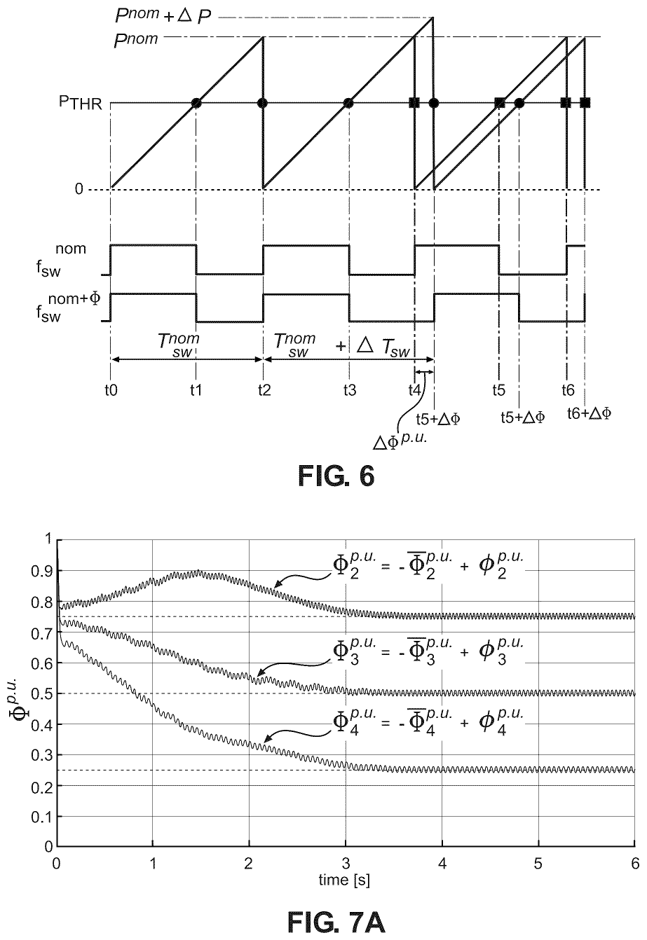

FIG. 4A illustrates an example functional block diagram of the controller of a power converting device according to some example embodiments. FIG. 4B illustrates an example functional block diagram of the power converting system according to some example embodiments. FIGS. 5A and 5B are flowcharts illustrating an example method of operating the power converting system according to at least one example embodiment. FIG. 6 is an example phase change control system according to at least one example embodiment.

Referring now to FIGS. 4A and 5A, each of the power converting devices VSI1 to VSIn may further include a controller 110 (e.g., processing circuitry). Each of the controllers 110 may control the operation of the one or more switches of its respective VSI, e.g., SW1 to SW4, using one or more control signals in order to control and/or adjust the switching frequency f_{sw} and/or the switching period T_{sw} (where T_{sw}=1/f_{sw}) of their respective power converting devices based on voltage phase shift calculations. By adjusting the switching frequency f_{sw} and/or the switching period T_{sw}, the controllers 110 may control, change and/or adjust the phase shift angle of the switched node voltages of their respective VSI (e.g., Vx1 to Vxn), thereby decreasing and/or minimizing the magnitude of the ripples in the current output by the VSIs, e.g., Ig.

Additionally, or alternatively, according to some example embodiments, a single power converting device, such as VSI1, may have a fixed switching frequency f_{sw} and the remaining N−1 power converting devices may perform the method of FIG. 5A to independently determine their total phase shifts Φᵢ. Or put another way, N power converting devices VSI may perform the operations of FIG. 5A, while an N+1th power converting device may have a fixed switching frequency.

In at least one example embodiment, the controller 110 may receive the grid current Ig. The grid current Ig may be considered a current associated with the plurality of power converting device VSI1 to VSIn, since the current Ig will be the same for each of the power converting devices because the plurality of power converting devices are connected in series. In operation S510, the controller 110 may sample and/or oversample the current Ig using the switch 2010. The current Ig may be sampled and/or oversampled at a sampling frequency calculated using the following equation:

$${f}_{ovs} = Ns * {f}_{sw} \qquad [ Equation 2 ]$$

where fₒᵥₛ is the sampling frequency; Ns is the desired number of samples per switching period; and f_{sw} is the switching frequency of the VSI.

According to some example embodiments, the desired number of samples per switching period Ns is any number of samples per switching period the controller 110 is capable of supporting. Further, the sampled current may be stored by the controller 110 in buffer memory 2020 of the controller 110 and/or the VSI. For example, the controller 110 may store the sampled current in the buffer memory via a direct memory access (DMA) operation in order to avoid interrupting the controller 110 upon each sampling instance, but the example embodiments are not limited thereto.

At operation S520, the controller 110 and/or the buffer memory 2020 may generate an interrupt signal using a switch 2030 at a rate using the following equation, but the example embodiments are not limited thereto:

$${f}_{c} = Nc * {f}_{sw} \qquad [ Equation 3 ]$$

where f_{c} is the interrupt frequency; Nc is the desired number of interrupts per switching period; and f_{sw} is the switching frequency of the VSI.

According to some example embodiments, the generated interrupts may coincide with and/or be used to perform other operations of the controller 110 and/or the VSI, such as performing power flow control of the VSI, etc. For example, the desired number of interrupts per switching period Nc may be set so that the controller 110 is interrupted once or twice during the switching period T_{sw}, but the example embodiments are not limited thereto.

In operation S530, the controller 110 may calculate a ripple cost function value yₙ using the buffered current samples of Ig. For example, the controller 110 may perform an AC root-mean-square (RMS) calculation on the buffered Ig current samples to calculate the ripple cost function value yₙ, but the example embodiments are not limited thereto, and for example, the controller 110 may calculate a ripple peak value, a squared RMS value, etc., of the buffered Ig current samples to calculate the ripple cost function yₙ.

In operation S540, the controller 110 may calculate and/or obtain an instantaneous phase shift perturbation value ϕᵢ using the following equation:

$${ϕ}_{i} = {A}_{i} sin ( {w}_{i} t ) \qquad [ Equation 4 ]$$

where Aᵢ=a magnitude of the perturbation; wᵢ=perturbation angular frequency; t=time.

While Equation 4 uses a sine wave function, the example embodiments are not limited thereto, and for example, other waveform functions may be used, such as a triangular waveform, square waveform, etc.

According to some example embodiments, an initial instantaneous phase shift perturbation value ϕᵢ may be a set value for an initial and/or first execution of the method of FIG. 5A (e.g., used during the system start-up, etc.), and is re-calculated and/or updated upon each execution of the method of FIG. 5A by the power converting device VSI. For example, each power converting device VSI may be set and/or configured with a different initial instantaneous phase shift perturbation value ϕᵢ by the manufacturer of the power converting device VSI, an operator of the power converting device VSI, etc., but the example embodiments are not limited thereto.

In operation S550, the controller 110 may determine the desired total phase shift of the VSI Φᵢ using an extremum seeking algorithm. The extremum seeking algorithm may be used to determine the correlation between the power converting device's phase shift perturbation value ϕᵢ and the resulting grid current Ig ripple cost function (e.g., the AC RMS value, etc.), by calculating, obtaining, and/or determining a gradient map of the ripple cost function in real-time and/or near-real-time and measuring its response to the set phase shift perturbation value ϕᵢ. The calculation of the extremum seeking algorithm will be discussed in greater detail in connection with FIGS. 4B and 5B.

Once the response to the phase shift perturbation value ϕᵢ is calculated, in operation S560, the controller 110 may generate a pulse-width-modulation (PWM) control signal based on the phase shift perturbation value ϕᵢ (and/or adjust the frequency of the PWM control signal) and transmit the PWM control signal to the switches (e.g., switches SW1 to SW4, etc.) of the VSI, to control the switching frequency of the VSI, thereby steering and/or directing the switched node voltage phases of the VSI (e.g., Vx1 to Vxn) output by the VSI to the desired total phase shift Φᵢ of the VSI, thereby decreasing and/or minimizing the magnitude of the ripples in the current Ig output by the VSIs as shown in FIG. 3B.

Referring now to FIG. 6, the controller 110 may control the switching frequency f_{sw} (and thereby control the duration of the switching period T_{sw}) of the power converting device VSI using a triangular PWM control signal (e.g., PWM carrier waveform, PWM carrier, etc.), where T_{sw}=1/f_{sw}. As shown in FIG. 6, at time t0, a rising edge of an “on” period of a nominal switching period T_{sw}-nom may correspond to when the voltage of the PWM control signal is at a valley (e.g., 0V, etc.), and at time t1, a falling edge of the “on” period may correspond to a time when the voltage of the PWM control signal reaches a modulating waveform and/or a target duty cycle (e.g., a desired threshold voltage level, a minimum threshold voltage level, etc.), and the switching period T_{sw} begins its “off” period. At time t2, the PWM control signal reaches its nominal maximum voltage level, e.g., Pnom, and falls (e.g., to 0V, etc.), which ends the “off” period of the duty cycle and begins the next “on” period of the switching period T_{sw}.

However, based on the results of operation S560, the controller 110 may transmit a corrective PWM control signal to the switches of the power converting device VSI, wherein the magnitude of the PWM control signal is increased by a ΔP value, where ΔP determines the desired total phase shift increment to be applied to the switching node voltage, the PWM pulse, and/or the switching waveform, etc. The ΔP may be calculated using the following equation:

$$( Δ P / Pnom ) = ( {ΔΦ}^{p . u .} / 1 ) \qquad [ Equation 5 ]$$

where ΔΦ^{p.u.} is a relative value of ΔP going from 0 to 1 (e.g., relative to the switching period T_{sw}), and where p.u. stands for per-unit normalization of the angle with respect to the switching period T_{sw}.

By increasing the magnitude of the PWM control signal by ΔP, the controller 110 may increase the “off” period of the switching period T_{sw} as shown at time t4+ΔΦᵢ. On the next pulse of the PWM control signal, the magnitude of the PWM control signal may return to Pnom, thereby returning the T_{sw} to its original value, but having the PWM pulse shift by the desired total phase shift increment value ΔΦᵢ.

While FIG. 6 illustrates a triangular PWM waveform with a trailing edge (e.g., an up-count sawtooth carrier), the example embodiments are not limited thereto, and for example, the controller 110 may generate a triangular PWM waveform with a leading edge (e.g., a down-count sawtooth carrier), a double-edge triangular waveform (e.g., an up-down count symmetrical triangular carrier), etc.

Returning now to FIGS. 4A and 5A, the controller 110 may generate PWM switching signals (e.g., square pulse signals, etc.) based on the PWM control signal, and may apply the PWM switching signals to the switches of the power converting device VSI, the controller 110 may return to operation S510 and continue to monitor the ripple in the current Ig and adjust the total phase shift Φᵢ in order to reduce and/or minimize the current ripple in the power converting system.

While FIG. 5A illustrates the operation of a single controller 110, one or more of the controllers 110 of the plurality of power converting devices VSI1 to VSIn will independently perform the operations of FIG. 5A in order to independently and/or autonomously reduce and/or minimize the current ripple in its output current Ig. In some example embodiments, all of the controllers 110 of the plurality of power converting devices VSI1 to VSIn may independently perform the operations of FIG. 5A, but the example embodiments are not limited thereto. In other example embodiments, one or more of the controllers 110 of the plurality of power converting devices may have fixed switching frequencies and the remaining power converting devices may monitor and control their total phase shifts Φᵢ, etc.

Referring now to FIGS. 4B and 5B, the determination of the total phase shift of one or more of the power converting devices VSI2 to VSIn using the extremum seeking algorithm will be described in greater detail. In FIG. 4B, it is assumed that power converting device VSI1 has a fixed switching frequency and the power converting devices VSI2 to VSIn may monitor and control their total phase shifts Φᵢ, but the example embodiments are not limited thereto, and for example, all of the power converting devices VSI to VSIn may monitor and control their total phase shifts Φᵢ.

In operation S551, each of the controllers 110₂ to 110_{N} will receive ripple cost function values y₂ to yₙ and may demodulate the ripple cost function values y₂ to yₙ using a demodulator 2052 based on the voltage phase shift perturbation value ϕ₂ to ϕₙ and a scaling factor from function 2051. In other words, the demodulator 2052 may extract a frequency component from the ripple cost function values y₂ to yₙ voltage phase shift perturbation values ϕ₂ to ϕₙ in order to see the impact of the voltage phase shift perturbation of the respective VSI and not the impact of the voltage phase shift perturbations from the other VSIs.

In operation S552, each of the controllers 110₂ to 110_{N} may filter the demodulated ripple cost function values y₂ to yₙ using a filter 2053 to attenuate undesired spectral components from the demodulated signal. According to at least one example embodiment, the filter 2053 may be at least one of a moving average filter, a low-pass filter, a notch filter, and/or a bandpass filter, etc. For example, the filter 2053 may be a moving average filter with an averaging window set to the period of the voltage phase shift perturbation value ϕ₂ to ϕₙ.

In operation S553, each of the controllers 110₂ to 110_{N} may compensate the filtered and demodulated cost function value using the compensator 2054 in order to have the system converge and increase stability, thereby obtaining a slowly varying phase shift Φ̅ᵢ. For example, the compensator 2054 may perform an integral control and apply a compensation gain kc to the filtered and demodulated cost function value, which changes the convergence speed of the cost function value, and steers the phase trajectory to be closer to a phase trajectory which results in a reduced and/or minimal current ripple AC RMS value. However, the example embodiments are not limited thereto, and for example, compensator 2054 may perform a proportional control, a proportional-integral control, proportional-integral-derivative control, a non-linear control, etc., on the filtered and demodulated cost function value.

In operation S554, each of the controllers 110₂ to 110_{N} may determine the total phase shift values Φ₂ to Φ_{N} by subtracting the slowly varying phase shift Φ̅₂ to Φ̅_{N} from the voltage phase shift perturbation value ϕ₂ to ϕₙ. Next, each of the controllers 110₂ to 110_{N} may generate and/or adjust a PWM control signal based on the determined total phase shift values Φ₂ to Φ_{N}, e.g., by determining the difference between the current total phase shift values Φ₂ to Φ_{N} and the previous total phase shift values Φ₂ to Φ_{N} of the previous interrupt instance. The controllers 110₂ to 110_{N} may generate PWM switching signals based on the PWM control signals and apply the PWM switching signals to the switching nodes of the respective power converting devices VSI2 to VSIn, etc.

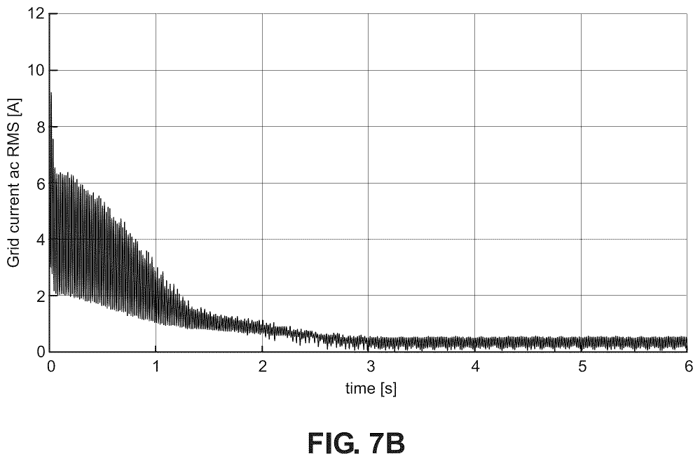

FIGS. 7A and 7B are example graphs illustrating the resulting changes in phase shift and AC current RMS of the example power converting system according to at least one example embodiment.

Referring to FIG. 7A, FIG. 7A illustrates a simulation result of the behavior of the total phase shifts of a power converting system according to one or more of the example embodiments. The system of FIG. 7A includes four VSIs connected in series and operating with a switching frequency f_{sw}=20 kHz, balanced DC-link voltages of 60V, and supplying a passive load with 60 Hz sinusoidal voltage. In FIG. 7A, one of the VSI's has a fixed switching frequency (not shown) and the remaining three VSIs employ the control algorithm of the example embodiments, with Tc=1/fc=1/f_{sw}=50 μs, perturbation frequencies set to [20, 24, 28] Hz and perturbation magnitudes equal to 1%, e.g., Ai=2π/100, and an integral gain set to kc=1.24 rad/s. As shown in FIG. 7A, the total phase shifts Φ₂ to Φ₄ of the three VSIs employing the control algorithm of one or more of the example embodiments converge from their initial values to improved and/or optimal phase shift values, e.g., 2π/4, 2π/2, and 6π/4, but the example embodiments are not limited thereto.

Additionally, FIG. 7B illustrates a simulation result of the response of the ripple cost functions of the system of FIG. 7A. As shown in FIG. 7B, the ripple cost functions of the four VSIs of the system of FIG. 7A converge to an improved and/or optimal value in correspondence to the improvement and/or optimization of the phase shift values in FIG. 7A.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A power converting system comprising:
a plurality of power converting devices electrically connected to each other, each of the plurality of power converting devices including at least one switching node; and
a plurality of controllers each connected to the plurality of power converting devices, each of the plurality of controllers configured to,
sample a current associated with the plurality of power converting devices electrically connected to each other over a desired time period,
obtain a ripple cost function value of the current associated with the plurality of power converting devices electrically connected to each other based on the samples of the current,
obtain a voltage phase shift perturbation value associated with the at least one switching node of the connected power converting device, and
control a switching frequency of the connected power converting device based on the ripple cost function value and the voltage phase shift perturbation value.

2. The system of claim 1, wherein each controller of the plurality of controllers is further configured to control the switching frequency of the connected power converting device by:
demodulating the ripple cost function value using the voltage phase shift perturbation value;
filtering the demodulated ripple cost function value; and
performing compensation on the filtered and demodulated cost function value.

3. The system of claim 2, wherein each controller of the plurality of controllers is further configured to perform compensation on the filtered and demodulated cost function value by performing at least one of:
integral control on the filtered and demodulated cost function value, proportional control on the filtered and demodulated cost function value, proportional-integral control on the filtered and demodulated cost function value, proportional-integral-derivative control on the filtered and demodulated cost function value, non-linear control on the filtered and demodulated cost function value, or any combinations thereof.

4. The system of claim 2, wherein each controller of the plurality of controllers is further configured to filter the demodulated ripple cost function value using at least one of:
a moving average filter, a low-pass filter, a notch filter, a bandpass filter, or any combinations thereof.

5. The system of claim 2, wherein each controller of the plurality of controllers is further configured to control the switching frequency of the connected power converting device by:
determining a total phase shift associated with the at least one switching node of the connected power converting device based on the voltage phase shift perturbation value and a compensated value of the demodulated and filtered ripple cost function value.

6. The system of claim 5, wherein each controller of the plurality of controllers is further configured to control the switching frequency of the connected power converting device by:
adjusting the switching frequency of at least one terminal of the connected power converting device based on the determined total phase shift.

7. The system of claim 6, wherein each controller of the plurality of controllers is further configured to control the switching frequency of the connected power converting device by:
obtaining a previous switching frequency of the at least one terminal of the connected power converting device; and
adjusting the switching frequency of the at least one terminal of the connected power converting device based on the determined total phase shift and the obtained previous switching frequency.

8. The system of claim 6, wherein
the plurality of controllers is equal to N controllers, wherein N is an integer greater than or equal to 1;
the plurality of power converting devices is equal to N power converting devices; and
the system further comprises,
an N+1th power converting device connected to the plurality of power converting devices, the N+1th power converting device including at least one N+1th switching node, and
an N+1th controller connected to the N+1th power converting device, the N+1th controller configured to provide a fixed switching frequency to the at least one N+1th switching node.

9. The system of claim 1, wherein the plurality of power converting devices are at least one of:
voltage source inverters, current source inverters, AC-DC converters, DC-DC converters, DC-AC converters, AC-AC converters, or any combinations thereof.

10. The system of claim 1, wherein the plurality of power converting devices are connected in series.

11. The system of claim 1, further comprising:
a plurality of photovoltaic (PV) modules connected to a corresponding power converting device of the plurality of power converting devices, each of the PV modules configured to,
harvest solar energy, and
output the harvested solar energy as direct current (DC) power to the corresponding power converting device, wherein
the corresponding power converting device is further configured to convert the DC power to the current associated with the plurality of power converting devices electrically connected to each other.

12. A method of operating a power converting system comprising:
sampling a current associated with a plurality of power converting devices over a desired time period, the plurality of power converting devices electrically connected to each other, each of the plurality of power converting devices including at least one switching node;
obtaining a ripple cost function value of the current associated with the plurality of power converting devices electrically connected to each other based on the samples of the current;
obtaining voltage phase shift perturbation values associated with each of the at least one switching nodes of the plurality of power converting devices; and
controlling a switching frequency of each power converting device of the plurality of power converting devices based on the ripple cost function value and the voltage phase shift perturbation value associated with the power converting device.

13. The method of claim 12, wherein the controlling the switching frequency of each of the power converting devices further includes:
demodulating the ripple cost function value associated with each of the power converting devices using the voltage phase shift perturbation value associated with the power converting device;
filtering the demodulated ripple cost function value associated with each of the power converting devices; and
performing compensation on the filtered and demodulated ripple cost function value associated with each of the power converting devices.

14. The method of claim 13, wherein the performing compensation on the filtered and demodulated cost function value includes at least one of:
performing integral control on the filtered and demodulated cost function value associated with each of the power converting devices, performing proportional control on the filtered and demodulated cost function value associated with each of the power converting devices, performing proportional-integral control on the filtered and demodulated cost function value associated with each of the power converting devices, performing proportional-integral-derivative control on the filtered and demodulated cost function value associated with each of the power converting devices, non-linear control on the filtered and demodulated cost function value, or any combinations thereof.

15. The method of claim 13, wherein the filtering the demodulated ripple cost function value further includes filtering the demodulated ripple cost function value using at least one of:
a moving average filter, a low-pass filter, a notch filter, a bandpass filter, or any combinations thereof.

16. The method of claim 13, wherein the controlling the switching frequency of each power converting device of the plurality of the power converting devices further includes:
determining a total phase shift associated with the at least one switching node of each of the power converting devices based on the voltage phase shift perturbation value associated with each of the converting devices and a compensated value of the demodulated and filtered ripple cost function value associated with each of the power converting devices.

17. The method of claim 16, wherein the controlling the switching frequency of each power converting device of the plurality of the power converting devices further includes:
obtaining a previous switching frequency of at least one terminal of each of the power converting devices; and
adjusting the switching frequency of the at least one terminal of each of the power converting devices based on the determined total phase shift and the obtained previous switching frequency of the at least one terminal of each of the power converting devices.

18. The method of claim 16, wherein
the plurality of power converting devices is equal to N power converting devices, wherein N is an integer equal to or greater than 1; and
the method further comprises,
controlling an N+1th power converting device connected to the plurality of power converting devices by providing a fixed switching frequency to at least one N+1th switching node included in the N+1th power converting device.

19. The method of claim 12, wherein
the plurality of power converting devices are at least one of,
voltage source inverters, current source inverters, AC-DC converters, DC-DC converters, DC-AC converters, AC-AC converters, or any combinations thereof;
the plurality of power converting devices are connected to a plurality of photovoltaic (PV) modules;
the plurality of power converting devices are connected in series; and
the method further comprises,
receiving solar energy harvested by the plurality of PV modules; and
converting the solar energy to the current associated with the plurality of power converting devices electrically connected to each other using each of the plurality of power converting devices.

20. A photovoltaic (PV) power converting system, the system comprising:
a plurality of power converting devices connected to a plurality of photovoltaic (PV) modules, the plurality of power converting devices electrically connected to each other, each of the plurality of power converting devices including at least one switching node; and
a plurality of controllers each connected to the plurality of power converting devices, each of the plurality of controllers configured to,
sample a current associated with the plurality of power converting devices electrically connected to each other over a desired time period,
obtain a ripple cost function value of the current associated with the plurality of power converting devices electrically connected to each other based on the samples of the current,
obtain a voltage phase shift perturbation value associated with the at least one switching node of the connected power converting device, and
control a switching frequency of the connected power converting device based on the ripple cost function value and the voltage phase shift perturbation value.
